(19) United States
(12) Patent Application Publication
(10) Pub. No.: US 2015/0370789 A1
(43) Pub. Date: Dec. 24, 2015

(54) MULTIMEDIA FILE STORAGE SYSTEM AND RELATED DEVICES

(71) Applicant: ELTA Technology Co., Ltd., Taipei City (TW)

(72) Inventors: Li-Wen CHEN, Taipei City (TW); Yu-Sheng HO, Taipei City (TW)

(73) Assignee: ELTA Technology Co., Ltd., Taipei City (TW)

(21) Appl. No.: 14/677,568

(22) Filed: Apr. 2, 2015

(30) Foreign Application Priority Data
Jun. 24, 2014 (TW) 103121784

(51) Int. Cl. G06F 17/30; H04N 19/177; H04L 29/06; H04N 19/23

(52) U.S. Cl. CPC G06F 17/3002; H04N 19/23; H04N 19/177; H04L 65/607; G06F 17/30097; G06F 17/3028; G06F 17/30371

(57) ABSTRACT

A multimedia file storage system, a related source-end device and a destination-end device are disclosed. The source-end device includes a source-end storage device for storing an original multimedia file; a source-end decoding circuit for decoding only a part of multiple B-pictures of the original multimedia file to form a source-end representative file; a source-end computing circuit for conducting a Hash algorithm computation based on the source-end representative file to generate a source-end check value; and a transmitting circuit for transmitting the source-end check value and the original multimedia file.

### CROSS-REFERENCE TO RELATED APPLICATIONS

This application claims the benefit of priority to Patent Application No. 103121784, filed in Taiwan on Jun. 24, 2014; the entirety of which is incorporated herein by reference for all purposes.

### BACKGROUND

The disclosure generally relates to a storage system and, more particularly, to a multimedia file storage system for effectively increasing the speed of file upload and consistency checking and related devices.

The reliability of data transmission is always an important concern, because of that errors occur during data transmission may lead to inconsistency between the original file and the file received at the receiving-end device, thereby causing troublesome for subsequent processing. For example, checking whether a multimedia file uploaded into a server is consistent with the original multimedia file is one of the key processes for ensuring the service quality of the multimedia service providers.

Therefore, the conventional multimedia file storage system typically conducts a Hash algorithm computation based on the full content of the multimedia file before uploading to the server to generate a source-end check value, and also conducts same Hash algorithm computation based on the full content of the multimedia file uploaded to the server to generate a destination-end check value. Then, the multimedia file storage system compares the source-end check value with the destination-end check value to determine whether the multimedia file uploaded to the server is consistent with the original multimedia file. For example, when the multimedia file storage system finds that the destination-end check value is different from the source-end check value, the multimedia file storage system determines that the multimedia file uploaded to the server is inconsistent with the original multimedia file. In this situation, the multimedia file storage system typically discards the multimedia file uploaded to the server, and requests the user to again upload the multimedia file.

As the progress of the multimedia applications, however, the file size of a single multimedia file has become larger and larger. In many applications, the file size of a single multimedia file may exceed tens or hundreds of terabyte (TB). The required time for conducting the Hash algorithm computation based on the full content of the multimedia file with such a huge file size is pretty considerable, and may even approximate to the required time for uploading the entire multimedia file to the server.

It is apparent that checking the consistency of multimedia files becomes the bottleneck for the transmission and storage of multimedia files with large file size, which severely affects the performance of the entire multimedia file storage system.

### SUMMARY

An example embodiment of a multimedia file storage system is disclosed, comprising: a source-end device and a destination-end device. The source-end device comprises: a source-end storage device, configured to operably store an original multimedia file; a source-end decoding circuit, coupled with the source-end storage device, configured to operably decode only a part of multiple B-pictures in the original multimedia file to form a source-end representative file; a source-end computing circuit, coupled with the source-end decoding circuit, configured to operably conduct a Hash algorithm computation based on the source-end representative file to generate a source-end check value; and a transmitting circuit, coupled with the source-end storage device and the source-end computing circuit, configured to operably transmit the source-end check value and the original multimedia file. The destination-end device comprises: a receiving circuit, configured to operably receive data transmitted from the transmitting circuit to form a destination-end multimedia file and obtain a source-end check value; a destination-end storage device, coupled with the receiving circuit, configured to operably store the destination-end multimedia file and the source-end check value; a destination-end decoding circuit, coupled with the destination-end storage device, configured to operably decode only a part of multiple B-pictures in the destination-end multimedia file to form a destination-end representative file; a destination-end computing circuit, coupled with the destination-end decoding circuit, configured to operably conduct the Hash algorithm computation based on the destination-end representative file to generate a destination-end check value; and a comparing circuit, coupled with the destination-end storage device and the destination-end computing circuit, configured to operably compare the destination-end check value with the source-end check value to determine whether the destination-end multimedia file is consistent with the original multimedia file.

Another example embodiment of a source-end device for use in a multimedia file storage system is disclosed, comprising: a source-end storage device, configured to operably store an original multimedia file; a source-end decoding circuit, coupled with the source-end storage device, configured to operably decode only a part of multiple B-pictures in the original multimedia file to form a source-end representative file; a source-end computing circuit, coupled with the source-end decoding circuit, configured to operably conduct a Hash algorithm computation based on the source-end representative file to generate a source-end check value; and a transmitting circuit, coupled with the source-end storage device and the source-end computing circuit, configured to operably transmit the source-end check value and the original multimedia file to a destination-end device of the multimedia file storage system.

Another example embodiment of a destination-end device for use in a multimedia file storage system is disclosed, comprising: a source-end device, comprising: a receiving circuit, configured to operably receive data transmitted from a source-end device of the multimedia file storage system to form a destination-end multimedia file and obtain a source-end check value; a destination-end storage device, coupled with the receiving circuit, configured to operably store the destination-end multimedia file and the source-end check value; a destination-end decoding circuit, coupled with the destination-end storage device, configured to operably decode only a part of multiple B-pictures in the destination-end multimedia file to form a destination-end representative file; a destination-end computing circuit, coupled with the destination-end decoding circuit, configured to operably conduct a Hash algorithm computation based on the destination-end representative file to generate a destination-end check value; and a comparing circuit, coupled with the destination-end storage device and the destination-end computing circuit, configured to operably compare the destination-end check value with the source-end check value to determine whether the destination-end multimedia file is consistent with an original multimedia file stored in the source-end device.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a multimedia file storage system according to one embodiment of the present disclosure.

FIG. 2 shows a simplified flowchart of a multimedia file storage method according to one embodiment of the present disclosure.

FIG. 3 shows a simplified schematic diagram of a GOP (group of picture) according to one embodiment of the present disclosure.

FIG. 4 shows a simplified schematic diagram of a GOP according to another embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

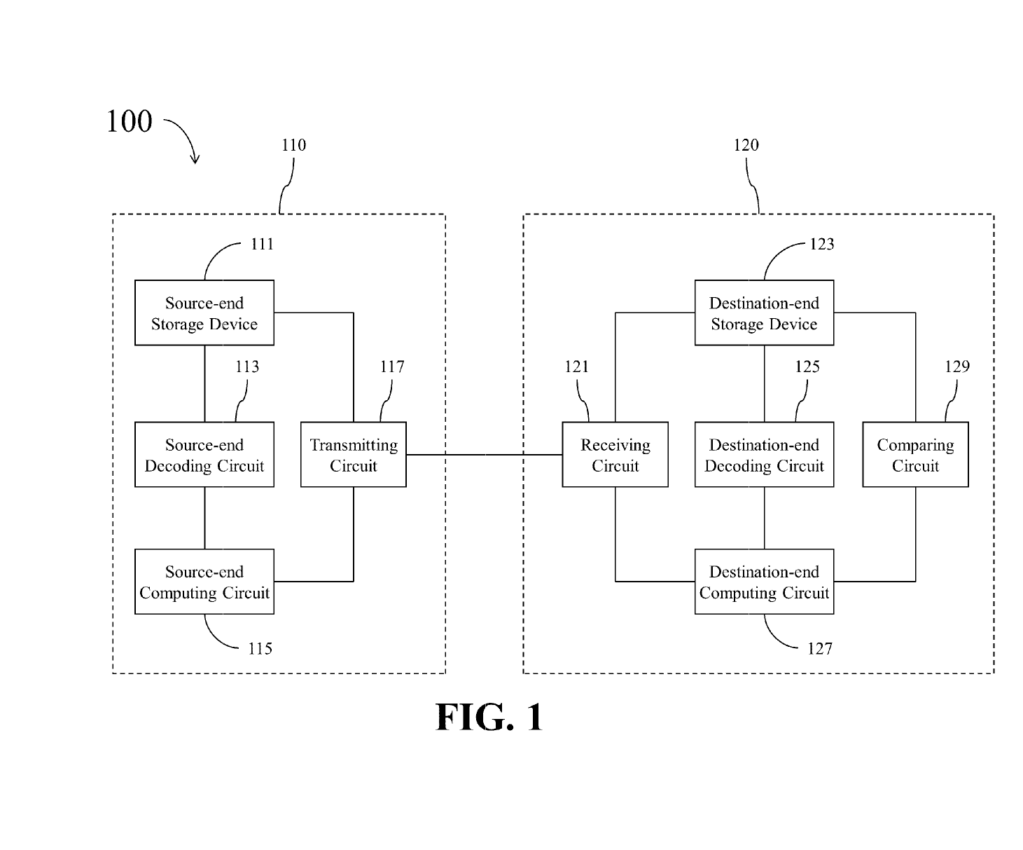

FIG. 1 shows a simplified functional block diagram of a multimedia file storage system 100 according to one embodiment of the present disclosure. The multimedia file storage system 100 comprises a source-end device 110 and a destination-end device 120.

In the embodiment of FIG. 1, the source-end device 110 comprises a source-end storage device 111, a source-end decoding circuit 113, a source-end computing circuit 115, and a transmitting circuit 117. The destination-end device 120 comprises a receiving circuit 121, a destination-end storage device 123, a destination-end decoding circuit 125, a destination-end computing circuit 127, and a comparing circuit 129.

In the source-end device 110, the source-end storage device 111 is configured to operably store an original multimedia file to be uploaded into the destination-end device 120. The source-end decoding circuit 113 is coupled with the source-end storage device 111 and configured to operably decode only a part of the pictures in the original multimedia file to form a source-end representative file. The source-end computing circuit 115 is coupled with the source-end decoding circuit 113 and configured to operably conduct a Hash algorithm computation based on the source-end representative file to generate a source-end check value. The transmitting circuit 117 is coupled with the source-end storage device 111 and the source-end computing circuit 115, and configured to operably transmit the source-end check value and the original multimedia file.

In the destination-end device 120, the receiving circuit 121 is configured to operably receive the data transmitted from the transmitting circuit 117 of the source-end device 110 to form a destination-end multimedia file and obtain the source-end check value. The destination-end storage device 123 is coupled with the receiving circuit 121 and configured to operably store the destination-end multimedia file and the source-end check value. The destination-end decoding circuit 125 is coupled with the destination-end storage device 123 and configured to operably decode only a part of the pictures in the destination-end multimedia file to form a destination-end representative file. The destination-end computing circuit 127 is coupled with the destination-end decoding circuit 125 and configured to operably conduct the Hash algorithm computation based on the destination-end representative file to generate a destination-end check value. The comparing circuit 129 is coupled with the destination-end storage device 123 and the destination-end computing circuit 127, and configured to operably compare the destination-end check value with the source-end check value to determine whether the destination-end multimedia file is consistent with the original multimedia file.

In practice, each of the transmitting circuit 117 and the receiving circuit 121 may be realized with a wired network interface, a wireless network interface, or a hybrid circuit integrated with the above two interfaces. In other words, the data communication between the transmitting circuit 117 and the receiving circuit 121 may be conducted through wired transmission or wireless transmission. The transmitting circuit 117 and/or the receiving circuit 121 may be further coupled with additional antenna devices (not shown) to increase the signal transmission quality of the transmitting circuit 117 and/or the receiving circuit 121.

In addition, different functional blocks of the source-end device 110 may be realized with separate circuits, or may be integrated into a single circuit chip. For example, at least two of the source-end decoding circuit 113, the source-end computing circuit 115, and the transmitting circuit 117 may be integrated onto a single processing circuit. Similarly, different functional blocks of the destination-end device 120 may be realized with separate circuits, or may be integrated into a single circuit chip. For example, at least two of the receiving circuit 121, the destination-end decoding circuit 125, the destination-end computing circuit 127, and the comparing circuit 129 may be integrated into a single processing circuit.

For simplicity of illustration, other components in the source-end device 110 and the destination-end device 120 and their connection relationship, operations, and implementations are not shown in FIG. 1.

The term “Hash algorithm” as used throughout the description and the claims refers to any algorithm for generating a check value (e.g., a digest) with smaller file size than the original file based on various Hash functions, such as a Message-Digest Algorithm (MD). Preferably, the aforementioned Hash algorithm refers to MD5 (Message-Digest Algorithm 5).

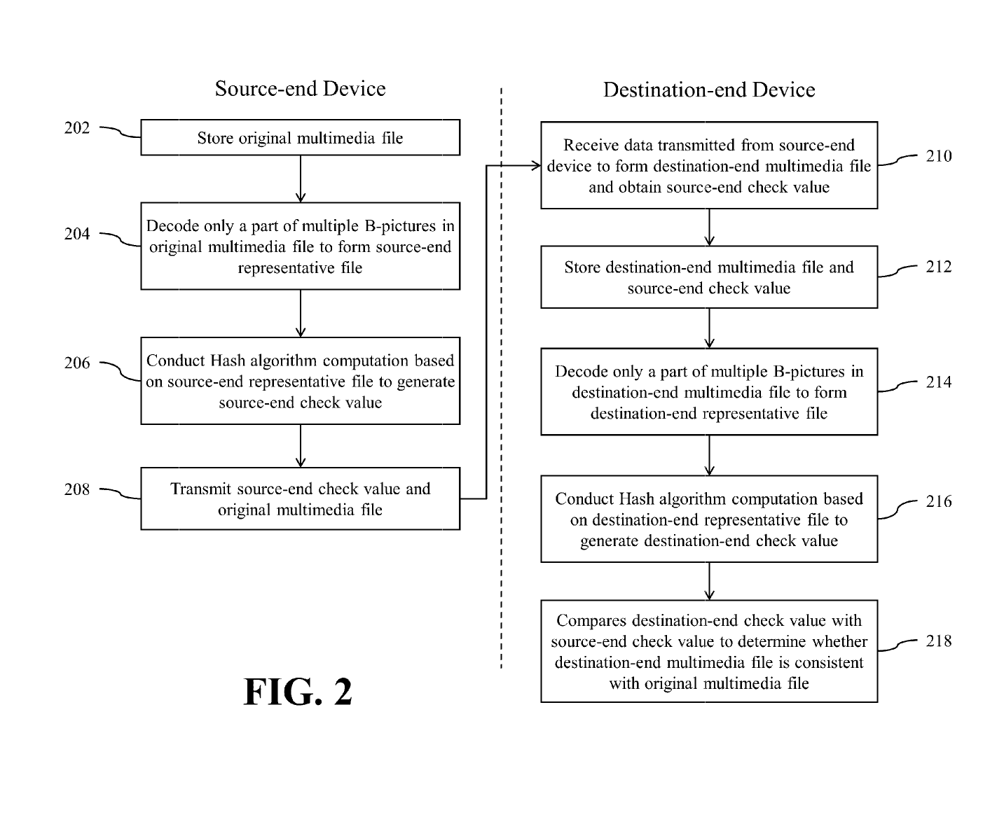

The operations of the multimedia file storage system 100 will be further described in the following by reference to FIG. 2.

FIG. 2 shows a simplified flowchart of a multimedia file storage method according to one embodiment of the present disclosure. In FIG. 2, operations within a column under the name of a specific device are operations to be performed by the specific device. For example, operations within a column under the label “Source-end Device” are operations to be performed by the source-end device 110, operations within a column under the label “Destination-end Device” are operations to be performed by the destination-end device 120.

Before the source-end device 110 uploads a specific original multimedia file to the destination-end device 120, the source-end storage device 111 may be utilized to perform the operation 202 to store the original multimedia file to be uploaded into the destination-end device 120.

The MPEG series standards (e.g., MPEG2 and MPEG 4) defined by the Moving Picture Experts Group (MPEG) are multimedia compression standards widely applied in various applications. The original multimedia file of this embodiment is a multimedia file generated by compressing the raw data based on the MPEG series standards.

The MPEG series standards defined three picture encoding modes, which are Intra Encoding mode, Predictive Encoding mode, and Bi-directionally Predictive mode.

An I-picture (Intra coded picture) is a picture ended independently and thus no other picture is referenced in encoding or decoding. A previous reference picture in the timeline is needed to be referenced in encoding or decoding a P-picture (predictive coded picture). A previous reference picture in the timeline and a next reference picture in the timeline are both needed to be referenced in encoding or decoding a B-picture (bidirectional predictive coded picture).

The aforementioned “reference picture” refers to an I-picture or a P-picture. The B-picture cannot be used as a reference picture, and it is thus also referred to as a non-reference picture. A certain number of reference pictures and non-reference pictures form a GOP (group of picture), but the arrangement pattern of the reference pictures and the non-reference pictures in the GOP varies depending upon the multimedia compression method adopted.

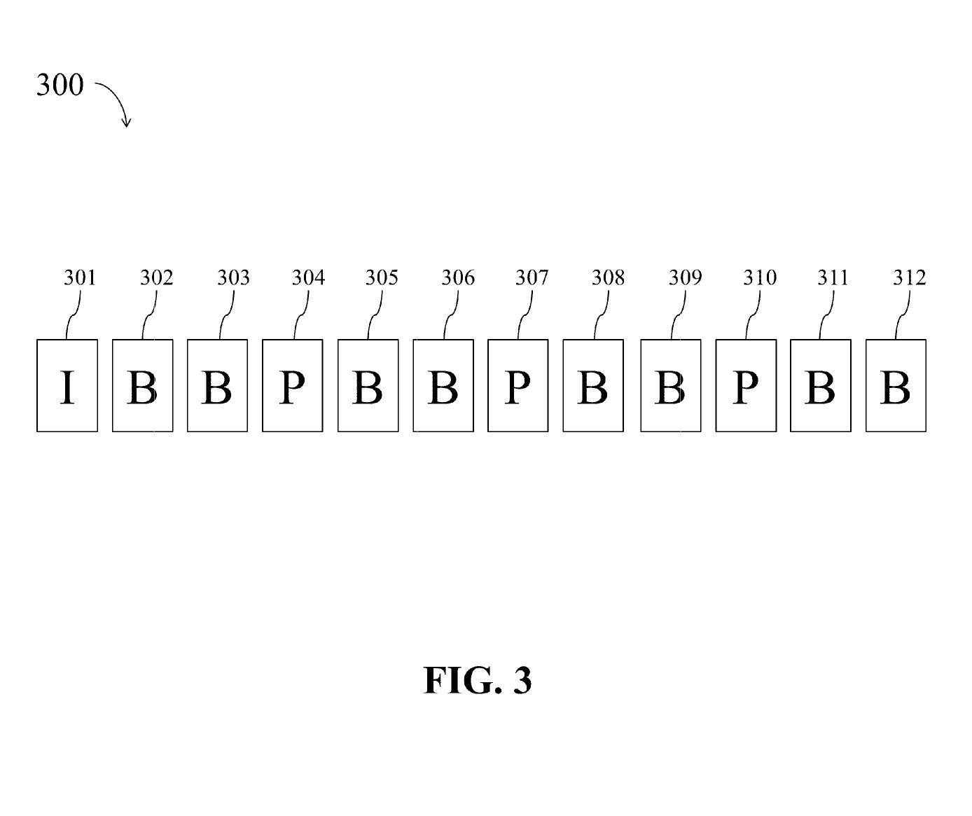

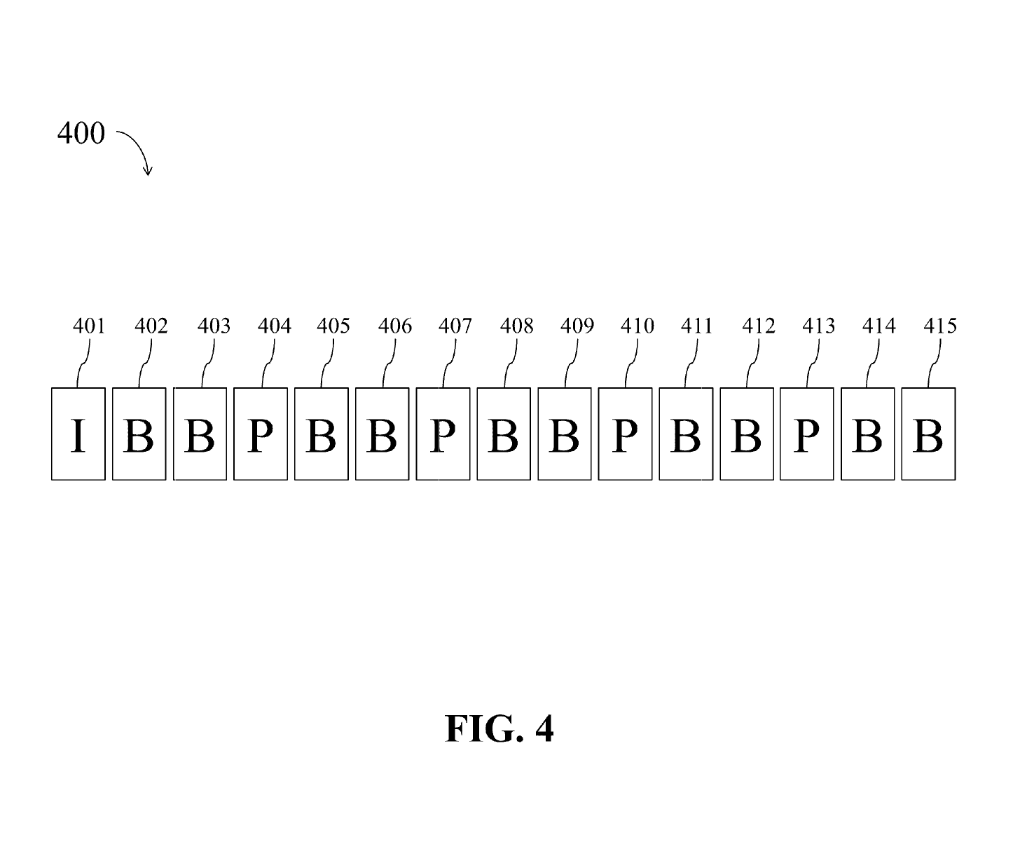

The MPEG series standards defined many GOP patterns, and for simplicity of illustration, only two GOP patterns illustrated in FIG. 3 and FIG. 4 are took as examples in the following descriptions.

FIG. 3 and FIG. 4 show simplified schematic diagrams of two GOPs according to different embodiments of the present disclosure. In the embodiment of FIG. 3, a GOP 300 is composed of twelve pictures, which are an I-picture 301, B-pictures 302 and 303, a P-picture 304, B-pictures 305 and 306, a P-picture 307, B-pictures 308 and 309, a P-picture 310, and B-pictures 311 and 312 in order. In the embodiment of GIG. 4, a GOP 400 is composed of fifteen pictures, which are an I-picture 401, B-pictures 402 and 403, a P-picture 404, B-pictures 405 and 406, a P-picture 407, B-pictures 408 and 409, a P-picture 410, B-pictures 411 and 412, a P-picture 413, and B-pictures 414 and 415.

In this embodiment, the original multimedia file comprises multiple GOPs. Accordingly, the original multimedia file comprises multiple I-pictures, multiple P-pictures, and multiple B -pictures.

In the operation 204, the source-end decoding circuit 113 decodes only a part of the pictures in the original multimedia file to form a source-end representative file with a smaller file size. In operations, the source-end decoding circuit 113 may decode only a part of the multiple B-pictures in the original multimedia file to form the source-end representative file.

In one embodiment, the source-end decoding circuit 113 decodes one B-picture of each GOP in the original multimedia file to obtain multiple source-end B-pictures and then combines the multiple source-end B-pictures to form the source-end representative file.

In practice, the source-end decoding circuit 113 may decode one of the B-pictures between the last two P-pictures of each GOP in the original multimedia file to obtain multiple source-end B-pictures, and then combines the multiple source-end B-pictures to form the source-end representative file. In the embodiments where each of the GOPs in the original multimedia file has the same pattern as the GOP 300 of FIG. 3, the source-end decoding circuit 113 may decode one of the B-pictures between the last two P-pictures 307 and 310 (i.e., either the B-picture 308 or the B-picture 309) of each GOP 300 in the original multimedia file to obtain multiple source-end B-pictures. In the embodiments where each of the GOPs in the original multimedia file has the same pattern as the GOP 400 of FIG. 4, the source-end decoding circuit 113 may decode one of the B-pictures between the last two P-pictures 410 and 413 (i.e., either the B-picture 411 or the B-picture 412) of each GOP 400 in the original multimedia file to obtain multiple source-end B-pictures.

Alternatively, the source-end decoding circuit 113 may decode one B-picture positioned after the last P-picture of each GOP in the original multimedia file to obtain multiple source-end B-pictures, and then combines the multiple source-end B-pictures to form the source-end representative file. In the embodiments where each of the GOPs in the original multimedia file has the same pattern as the GOP 300 of FIG. 3, the source-end decoding circuit 113 may decode one of the B-pictures positioned after the last P-picture 310 (i.e., either the B-picture 311 or the B-picture 312) of each GOP 300 in the original multimedia file to obtain multiple source-end B-pictures. In the embodiments where each of the GOPs in the original multimedia file has the same pattern as the GOP 400 of FIG. 4, the source-end decoding circuit 113 may decode one of the B-pictures positioned after the last P-picture 413 (i.e., either the B-picture 414 or the B-picture 415) of each GOP 400 in the original multimedia file to obtain multiple source-end B-pictures.

In the operation 206, the source-end computing circuit 115 conducts the aforementioned Hash algorithm computation based on the source-end representative file formed by the source-end decoding circuit 113 to generate a source-end check value. Since the source-end representative file is composed of only some B-pictures in the original multimedia file, the file size of the source-end representative file is much less than the file size of the original multimedia file, thereby significantly reducing the time required by the source-end computing circuit 115 in generating the source-end check value.

In the operation 208, the transmitting circuit 117 transmits the source-end check value and the original multimedia file to the destination-end device 120.

In the operation 210, the receiving circuit 121 of the destination-end device 120 receives the data transmitted from the transmitting circuit 117 of the source-end device 110 to form a destination-end multimedia file and obtain the source-end check value generated by the source-end device 110.

At this time, the destination-end storage device 123 performs the operation 212 to store the destination-end multimedia file and the source-end check value.

In the operation 214, the destination-end decoding circuit 125 decodes only a part of the pictures in the destination-end multimedia file to form a destination-end representative file. In operations, the destination-end decoding circuit 125 may decode only a part of the multiple B-pictures in the destination-end multimedia file to form the destination-end representative file.

In one embodiment, the destination-end decoding circuit 125 decodes one B-picture of each GOP in the destination-end multimedia file to obtain multiple destination-end B-pictures, and then combines the multiple destination-end B-pictures to form the destination-end representative file.

In practice, the destination-end decoding circuit 125 in the operation 214 may decode one of the B-pictures between the last two P-pictures of each GOP in the destination-end multimedia file to obtain multiple destination-end B-pictures, and then combines the multiple destination-end B-pictures to form the destination-end representative file. In the embodiment where each of the GOPs in the destination-end multimedia file has the same pattern as the GOP 300 of FIG. 3, the destination-end decoding circuit 125 may decode one of the B-pictures between the last two P-pictures 307 and 310 (i.e., either the B-picture 308 or the B-picture 309) of each GOP 300 in the destination-end multimedia file to obtain multiple destination-end B-pictures. In this embodiment, the position of the B-picture within the corresponding GOP 300 decoded by the destination-end decoding circuit 125 in the operation 214 is the same as the position of the B-picture within the corresponding GOP 300 decoded by the source-end decoding circuit 113 in the operation 204. For example, if the B-picture decoded by the source-end decoding circuit 113 in the operation 204 is the first B-picture 308 between the last two P-pictures 307 and 310 of each GOP 300 in the original multimedia file, then the destination-end decoding circuit 125 would decode the first B-picture 308 between the last two P-pictures 307 and 310 of each GOP 300 in the destination-end multimedia file in the operation 214. In another example, if the B-picture decoded by the source-end decoding circuit 113 in the operation 204 is the second B-picture 309 between the last two P-pictures 307 and 310 of each GOP 300 in the original multimedia file, then the destination-end decoding circuit 125 would decode the second B-picture 309 between the last two P-pictures 307 and 310 of each GOP 300 in the destination-end multimedia file in the operation 214.

In the embodiment where each of the GOPs in the destination-end multimedia file has the same pattern as the GOP 400 of FIG. 4, the destination-end decoding circuit 125 may decode one of the B-pictures between the last two P-pictures 410 and 413 (i.e., either the B-picture 411 or the B-picture 412) of each GOP 400 in the destination-end multimedia file to obtain multiple destination-end B-pictures. In this embodiment, the position of the B-picture within the corresponding GOP 400 decoded by the destination-end decoding circuit 125 in the operation 214 is the same as the position of the B-picture within the corresponding GOP 400 decoded by the source-end decoding circuit 113 in the operation 204. For example, if the B-picture decoded by the source-end decoding circuit 113 in the operation 204 is the first B-picture 411 between the last two P-pictures 410 and 413 of each GOP 400 in the original multimedia file, then the destination-end decoding circuit 125 would decode the first B-picture 411 between the last two P-pictures 410 and 413 of each GOP 400 in the destination-end multimedia file in the operation 214. In another example, if the B-picture decoded by the source-end decoding circuit 113 in the operation 204 is the second B-picture 412 between the last two P-pictures 410 and 413 of each GOP 400 in the original multimedia file, then the destination-end decoding circuit 125 would decode the second B-picture 412 between the last two P-pictures 410 and 413 of each GOP 400 in the destination-end multimedia file in the operation 214.

Alternatively, the destination-end decoding circuit 125 may decode one of the B-pictures positioned after the last P-picture of each GOP in the destination-end multimedia file to obtain multiple destination-end B-pictures, and then combines the multiple destination-end B-pictures to form the destination-end representative file. In the embodiment where each of the GOPs in the destination-end multimedia file has the same pattern as the GOP 300 of FIG. 3, the destination-end decoding circuit 125 may decode one of the B-pictures positioned after the last P-picture 310 (i.e., either the B-picture 311 or the B-picture 312) of each GOP 300 in the destination-end multimedia file to obtain multiple destination-end B-pictures. In this embodiment, the position of the B-picture within the corresponding GOP 300 decoded by the destination-end decoding circuit 125 in the operation 214 is the same as the position of the B-picture within the corresponding GOP 300 decoded by the source-end decoding circuit 113 in the operation 204. For example, if the B-picture decoded by the source-end decoding circuit 113 in the operation 204 is the first B-picture 311 positioned after the last P-picture 310 of each GOP 300 in the original multimedia file, then the destination-end decoding circuit 125 would decode the first B-picture 311 positioned after the last P-picture 310 of each GOP 300 in the destination-end multimedia file in the operation 214. In another example, if the B-picture decoded by the source-end decoding circuit 113 in the operation 204 is the second B-picture 312 positioned after the last P-picture 310 of each GOP 300 in the original multimedia file, then the destination-end decoding circuit 125 would decode the second B-picture 312 positioned after the last P-picture 310 of each GOP 300 in the destination-end multimedia file in the operation 214.

In the embodiment where each of the GOPs in the destination-end multimedia file has the same pattern as the GOP 400 of FIG. 4, the destination-end decoding circuit 125 may decode one of the B-pictures positioned after the last P-picture 413 (i.e., either the B-picture 414 or the B-picture 415) of each GOP 400 in the destination-end multimedia file to obtain multiple destination-end B-pictures. In this embodiment, the position of the B-picture within the corresponding GOP 400 decoded by the destination-end decoding circuit 125 in the operation 214 is the same as the position of the B-picture within the corresponding GOP 400 decoded by the source-end decoding circuit 113 in the operation 204. For example, if the B-picture decoded by the source-end decoding circuit 113 in the operation 204 is the first B-picture 414 positioned after the last P-picture 413 of each GOP 400 in the original multimedia file, then the destination-end decoding circuit 125 would decode the first B-picture 414 positioned after the last P-picture 413 of each GOP 400 in the destination-end multimedia file in the operation 214. In another example, if the B-picture decoded by the source-end decoding circuit 113 in the operation 204 is the second B-picture 415 positioned after the last P-picture 413 of each GOP 400 in the original multimedia file, then the destination-end decoding circuit 125 would decode the second B-picture 415 positioned after the last P-picture 413 of each GOP 400 in the destination-end multimedia file in the operation 214.

In the operation 216, the destination-end computing circuit 127 conducts the aforementioned Hash algorithm computation based on the destination-end representative file formed by the destination-end decoding circuit 125 to generate a destination-end check value. Since the destination-end representative file is composed of only some B-pictures in the destination-end multimedia file, the file size of the destination-end representative file is much less than the file size of the destination-end multimedia file, thereby significantly reducing the time required by the destination-end computing circuit 127 in generating the destination-end check value.

In the operation 218, the comparing circuit 129 compares the destination-end check value generated by the destination-end computing circuit 127 with the source-end check value generated by the source-end device 110 to determine whether the destination-end multimedia file is consistent with the original multimedia file.

In normal situation, if there is no error occurred during the data transmission between the transmitting circuit 117 and the receiving circuit 121, the destination-end representative file formed by the destination-end decoding circuit 125 in the operation 214 would be theoretically the same as the source-end representative file formed by the source-end decoding circuit 113 in the operation 204, and the destination-end check value generated by the destination-end computing circuit 127 in the operation 216 would be theoretically the same as the source-end check value generated by the source-end computing circuit 115 in the operation 206. Accordingly, when the comparing circuit 129 finds that the destination-end check value is identical to the source-end check value, the comparing circuit 129 determines that the destination-end representative file in the destination-end device 120 is identical to the source-end representative file in the source-end device 110, and thus determines that the destination-end multimedia file in the destination-end device 120 is consistent with the original multimedia file in the source-end device 110.

On the contrary, when the comparing circuit 129 finds that the destination-end check value is different from the source-end check value, the comparing circuit 129 determines that the destination-end representative file in the destination-end device 120 is different from the source-end representative file in the source-end device 110, and thus determines that the destination-end multimedia file in the destination-end device 120 is inconsistent with the original multimedia file in the source-end device 110. In this situation, the comparing circuit 129 may instruct the destination-end storage device 123 to discard the destination-end multimedia file and request the user to re-upload the multimedia file.

As can be appreciated from the foregoing elaborations that the source-end decoding circuit 113 combines only a part of the B-pictures of the original multimedia file to form the source-end representative file, and thus the file size of the source-end representative file would be much less than the file size of the original multimedia file. As a result, the required time for the source-end computing circuit 115 to generate the source-end check value based on the source-end representative file would be much less than the required time for generating the source-end check value based on the full content of the original multimedia file. On the other hand, since the destination-end decoding circuit 125 combines only a part of the B-pictures of the destination-end multimedia file to from the destination-end representative file, the files size of the destination-end representative file would be less than the file size of the destination-end multimedia file. As a result, the required time for the destination-end computing circuit 127 to generate the destination-end check value based on the destination-end representative file would be much less than the required time for generating the destination-end check value based on the full content of the destination-end multimedia file.

Accordingly, the required time for the destination-end device 120 to check whether the destination-end multimedia file is consistent with the original multimedia file in the source-end device 110 could be significantly reduced by adopting the foregoing method. As a result, the consistency checking process is no longer the bottleneck for the transmission and storage of the multimedia file with large file size.

In addition, the aforementioned approach for combining only a part of the B-pictures of the original multimedia file to form the source-end representative file could also reduce the possibility of collision among different source-end check values respectively generated based on different original multimedia files. Similarly, the aforementioned approach for combining only a part of the B-pictures of the destination-end multimedia file to form the destination-end representative file could also reduce the possibility of collision among different destination-end check values respectively generated based on different destination-end multimedia files.

Furthermore, since the aforementioned destination-end representative file is composed of partial B-pictures in the destination-end multimedia file, errors occurred during the transmission of other I-pictures and/or P-pictures of the destination-end multimedia file would also reflect in the destination-end representative file in almost all cases, thereby causing difference to be present between the destination-end check value and the source-end check value. Accordingly, the aforementioned approach for generating the source-end check value and the destination-end check value could also effectively avoid degrading the error detection ability of the comparing circuit 129 with respect to the destination-end multimedia file.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A multimedia file storage system, comprising:
a source-end device, comprising:
a source-end storage device, configured to operably store an original multimedia file;
a source-end decoding circuit, coupled with the source-end storage device, configured to operably decode only a part of multiple B-pictures in the original multimedia file to form a source-end representative file;
a source-end computing circuit, coupled with the source-end decoding circuit, configured to operably conduct a Hash algorithm computation based on the source-end representative file to generate a source-end check value; and
a transmitting circuit, coupled with the source-end storage device and the source-end computing circuit, configured to operably transmit the source-end check value and the original multimedia file; and
a destination-end device, comprising:
a receiving circuit, configured to operably receive data transmitted from the transmitting circuit to form a destination-end multimedia file and obtain a source-end check value;
a destination-end storage device, coupled with the receiving circuit, configured to operably store the destination-end multimedia file and the source-end check value;
a destination-end decoding circuit, coupled with the destination-end storage device, configured to operably decode only a part of multiple B-pictures in the destination-end multimedia file to form a destination-end representative file;
a destination-end computing circuit, coupled with the destination-end decoding circuit, configured to operably conduct the Hash algorithm computation based on the destination-end representative file to generate a destination-end check value; and
a comparing circuit, coupled with the destination-end storage device and the destination-end computing circuit, configured to operably compare the destination-end check value with the source-end check value to determine whether the destination-end multimedia file is consistent with the original multimedia file.

2. The multimedia file storage system of claim 1, wherein the source-end decoding circuit decodes one B-picture of each GOP (group of picture) in the original multimedia file to obtain multiple source-end B-pictures and combines the multiple source-end B-pictures to form the source-end representative file, and the destination-end decoding circuit decodes one B-picture of each GOP in the destination-end multimedia file to obtain multiple destination-end B-pictures and combines the multiple destination-end B-pictures to form the destination-end representative file.

3. The multimedia file storage system of claim 1, wherein the source-end decoding circuit decodes one B-picture between last two P-pictures of each GOP in the original multimedia file to obtain multiple source-end B-pictures and combines the multiple source-end B-pictures to form the source-end representative file, and the destination-end decoding circuit decodes one B-picture between last two P-pictures of each GOP in the destination-end multimedia file to obtain multiple destination-end B-pictures and combines the multiple destination-end B-pictures to form the destination-end representative file.

4. The multimedia file storage system of claim 1, wherein the source-end decoding circuit decodes one B-picture positioned after a last P-picture of each GOP in the original multimedia file to obtain multiple source-end B-pictures and combines the multiple source-end B-pictures to form the source-end representative file, and the destination-end decoding circuit decodes one B-picture positioned after a last P-picture of each GOP in the destination-end multimedia file to obtain multiple destination-end B-pictures and combines the multiple destination-end B-pictures to form the destination-end representative file.

5. The multimedia file storage system of claim 1, wherein the Hash algorithm is MD5 (Message-Digest Algorithm 5).

6. A source-end device for use in a multimedia file storage system, the source-end device comprising:
a source-end storage device, configured to operably store an original multimedia file;
a source-end decoding circuit, coupled with the source-end storage device, configured to operably decode only a part of multiple B-pictures in the original multimedia file to form a source-end representative file;
a source-end computing circuit, coupled with the source-end decoding circuit, configured to operably conduct a Hash algorithm computation based on the source-end representative file to generate a source-end check value; and
a transmitting circuit, coupled with the source-end storage device and the source-end computing circuit, configured to operably transmit the source-end check value and the original multimedia file to a destination-end device of the multimedia file storage system.

7. The source-end device of claim 6, wherein the source-end decoding circuit decodes one B-picture of each GOP (group of picture) in the original multimedia file to obtain multiple source-end B-pictures and combines the multiple source-end B-pictures to form the source-end representative file.

8. The source-end device of claim 6, wherein the source-end decoding circuit decodes one B-picture between last two P-pictures of each GOP in the original multimedia file to obtain multiple source-end B-pictures and combines the multiple source-end B-pictures to form the source-end representative file.

9. The source-end device of claim 6, wherein the source-end decoding circuit decodes one B-picture positioned after a last P-picture of each GOP in the original multimedia file to obtain multiple source-end B-pictures and combines the multiple source-end B-pictures to form the source-end representative file.

10. The source-end device of claim 6, wherein the Hash algorithm is MD5 (Message-Digest Algorithm 5).

11. A destination-end device for use in a multimedia file storage system, the destination-end device comprising:
a source-end device, comprising:
a receiving circuit, configured to operably receive data transmitted from a source-end device of the multimedia file storage system to form a destination-end multimedia file and;
a destination-end storage device, coupled with the receiving circuit, configured to operably store the destination-end multimedia file and the source-end check value;
a destination-end decoding circuit, coupled with the destination-end storage device, configured to operably decode only a part of multiple B-pictures in the destination-end multimedia file to form a destination-end representative file;
a destination-end computing circuit, coupled with the destination-end decoding circuit, configured to operably conduct a Hash algorithm computation based on the destination-end representative file to generate a destination-end check value; and
a comparing circuit, coupled with the destination-end storage device and the destination-end computing circuit, configured to operably compare the destination-end check value with the source-end check value to determine whether the destination-end multimedia file is consistent with an original multimedia file stored in the source-end device.

12. The destination-end device of claim 11, wherein the destination-end decoding circuit decodes one B-picture of each GOP in the destination-end multimedia file to obtain multiple destination-end B-pictures and combines the multiple destination-end B-pictures to form the destination-end representative file.

13. The destination-end device of claim 11, wherein the destination-end decoding circuit decodes one B-picture between last two P-pictures of each GOP in the destination-end multimedia file to obtain multiple destination-end B-pictures and combines the multiple destination-end B-pictures to form the destination-end representative file.

14. The destination-end device of claim 11, wherein the destination-end decoding circuit decodes one B-picture positioned after a last P-picture of each GOP in the destination-end multimedia file to obtain multiple destination-end B-pictures and combines the multiple destination-end B-pictures to form the destination-end representative file.

15. The destination-end device of claim 11, wherein the Hash algorithm is MD5 (Message-Digest Algorithm 5).
